(19) United States
(12) Patent Application Publication
(10) Pub. No.: US 2013/0130092 A1
(43) Pub. Date: May 23, 2013

(54) SEPARATOR WITH INCREASED PUNCTURE RESISTANCE

(71) Applicants: Michael Roth, Mainz (DE); Christoph Weber, Laudenbach (DE); Margitta Berg, Birkenau (DE); Sigrid Geiger, Birkenau (DE); Klaus Hirn, Hirschberg (DE); Christian Waschinski, Heidelberg (DE); Sandra Falusi, Mannheim (DE); Maxim Kasai, Berlin (DE)

(72) Inventors: Michael Roth, Mainz (DE); Christoph Weber, Laudenbach (DE); Margitta Berg, Birkenau (DE); Sigrid Geiger, Birkenau (DE); Klaus Hirn, Hirschberg (DE); Christian Waschinski, Heidelberg (DE); Sandra Falusi, Mannheim (DE); Maxim Kasai, Berlin (DE)

(73) Assignee: CARL FREUDENBERG KG, Weinheim (DE)

(21) Appl. No.: 13/813,455

(22) PCT Filed: Aug. 11, 2010
(86) PCT No.: PCT/EP10/04912

§ 371 Date: Jan. 31, 2013

(51) Int. Cl. H01M 2/16

(52) U.S. Cl. CPC H01M 2/1626
USPC 429/144

(57) ABSTRACT

A separator with a main part which is made of nonwoven material, and is provided with a coating. The coating contains filler particles, cellulose, and flexible organic binder particles. The filler particles and flexible organic binder particles are connected to each other by the cellulose. Such a separator exhibits high permeability with increased mechanical stability. The cellulose of the separator contains cellulose derivatives that have a chain length of at least 100 repeating units, preferably a chain length of at least 200 repeating units.

### CROSS REFERENCE TO RELATED APPLICATIONS

This application is a U.S. national phase application under 35 U.S.C. §371 of International Application No. PCT/EP2010/004912, filed on Aug. 11, 2010. The international application was published in German on Feb. 16, 2012, as WO 2012/019626 A1 under PCT Article 21(2).

### FIELD

This application relates to a separator useful, for example, in batteries.

### BACKGROUND

Separators of the above-mentioned type are already known from International patent application WO 2009/033627 A1. These separators are coated with filler particles and can be used in Li-ion cells or capacitors.

A failure of Li-ion cells can be due to external or internal causes. Possible external causes can include a flawed battery management system or failing temperature control. Internal failures can be due to the cell chemistry, degradation processes or internal short circuits.

The external causes can only be partially influenced by the design of the cell. The internal causes, however, should be reduced or eliminated in order to achieve a long service life for high-capacitance Li-ion cells.

About 90% of all cell failures in Li-ion batteries are due to internal short circuits. An internal short circuit occurs when, during the operation of a battery, one or more electrode particles push their way through the separator and form an electrically conductive path that causes a short circuit.

In case of a short circuit, the spontaneous discharging of the cell results in very strong localized heat generation that causes many separators to shrink or melt. In the best case scenario, this “only” causes a failure, but in the worst case scenario, this leads to an explosion or ignition of the cell. The larger the cells are, the more problematic the above-mentioned processes, since the energy stored in the cell is correlated with its capacity.

Commonly used permeable porous separators on the basis of polyolefin membranes or else ceramic separators have good electric properties, which have come to the fore over the past 15 years in the form of the greater energy density or power density of Li-ion cells.

A drawback of these separators, however, is their thermal and mechanical properties. Thus, for example, polypropylene and polyethylene have a low melting point, and porous membranes made of these materials exhibit high shrinkage and therefore limited mechanical stability.

Additional weak points are especially the low puncture resistance and tear propagation resistance of polyolefin membranes as well as of ceramic separators. These weak points repeatedly lead to cell failures, at times dramatic.

Unfortunately, the mechanical properties of the separators influence not only the safety of electrochemical cells but also their electric properties. As soon as the mechanical properties of a separator are improved, for example, in order to increase its puncture resistance, a denser separator has to be used if the structure remains the same. This, however, is associated with a reduced porosity and thus an increased electric resistance in the cell, since the electrolyte cannot diffuse through the membrane as readily.

Therefore, the invention is based on the objective of configuring and refining a separator of the type described above in such a way that it displays a high permeability, along with increased mechanical stability.

### SUMMARY

An aspect of the present invention achieves the above-mentioned objective by providing a separator, comprising a body of nonwoven, the body comprising a coating, wherein the coating comprises: filler particles; cellulose; flexible organic binder particles, wherein the filler particles and the flexible organic binder particles are joined to each other by the cellulose, and wherein the cellulose comprises a cellulose derivative having a chain length of at least 100 repeat units.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 a measuring arrangement for determining the puncture resistance of separators,

FIG. 2 a diagram comparing the puncture resistance of separators,

FIG. 3 a diagram that shows the tear propagation resistance of separators in the lengthwise direction,

FIG. 4 a diagram that shows the tear propagation resistance of separators in the crosswise direction,

FIG. 5 a diagram that shows the Gurley units for separators,

FIG. 6 a schematic representation of a specimen for carrying out the tear propagation resistance test, and

FIG. 7 a scanning electron microscope (SEM) image of embodiment 3, confirming the uniformity and high quality of the coating or impregnation.

### DETAILED DESCRIPTION

According to an aspect of the invention, the cellulose derivatives used have a chain length of at least 100 repeat units (degree of polymerization (DP)=100), preferably a chain length of at least 200 repeat units. Surprisingly, this leads to greatly improved mechanical properties. Through the use of selected modified cellulose derivatives, surprisingly, the homogeneity and stability of the coating solution and thus also of the coating of the separator can be decisively improved.

According to the invention, the safety during the operation of Li-ion cells is markedly improved by such a separator. It has surprisingly been found that particularly good mechanical properties are displayed by a nonwoven coated with cellulose derivatives, whereby the coating contains hard organic or inorganic filler particles and organic flexible binder particles. Moreover, the use of cellulose derivatives surprisingly leads to a homogeneous coating. Also surprisingly, a very high puncture resistance and a very high tear propagation resistance are obtained, which had not yet been found in similar separators of the state of the art. The risk of an internal short circuit is greatly diminished by the improved mechanical properties, while the permeability of the separator is not negatively impacted. This is evident from a very low Gurley unit, which is a unit of measurement that is a readily accessible and widespread in technical circles for determining the permeability or tortuosity of porous membranes. A low Gurley unit ensures a problem-free microscopic mass transfer through the separator. The mass transfer correlates with the resistance in the battery cell. Thus, a separator is being put forward that displays a high permeability, along with increased mechanical stability.

Consequently, the above-mentioned objective can be achieved.

The cellulose derivatives could be in the form of cellulose ether and/or cellulose ester. The cellulose derivatives cellulose ether and cellulose ester yield particularly stable separators. The cellulose derivatives have a substitution degree of 0.7, preferably 0.9, in order to form an optimal hydrophilic mass in the coating solution. In this manner, first of all, surprisingly good film-forming properties are attained for the coating solution, and secondly, agglomeration of the filler particles is reliably prevented. In this way, a virtually perfect homogeneous coating is obtained.

Through the use of special surfactants, namely, non-ionic surfactants, the homogeneity and stability of the coating solutions, and thus also of the coating of the separator, can be significantly improved. This surprisingly leads to the greatly improved mechanical properties. Through the use of small fractions of non-ionic surfactants amounting to less than 5%, preferably less than 2%, especially preferably less than 1%, in the solids content of the coating, the homogeneity and uniformity of the mixture can surprisingly be greatly improved.

The coating could contain non-ionic surfactants having octylphenol ethoxylates and/or nonylphenol ethoxylates and/or alkylated ethylene oxide/polypropylene oxide copolymers. These surfactants are especially well-suited for positively influencing the homogeneity of the coating solution. Ionic surfactants, in contrast, can cause agglomeration of the filler particles and thus lead to demixing and/or coagulation of the charged filler particles in the coating solution.

The flexible organic binder particles could make up a fraction of at least 2% by weight, preferably at least 5% by weight, especially preferably at least 10% by weight, of the coating. In this manner, a very high puncture resistance and tear propagation resistance are achieved for the separator and, at the same time, a surprisingly high permeability to air. A fraction of at least 11% results in a particularly high puncture resistance for the separator.

The binder particles could have a size of less than 1 μm (d₅₀), preferably less than 0.5 μm (d₅₀), and especially preferably less than 0.3 μm (d₅₀). The d₅₀ value refers to the mean size or mean diameter of the particles.

The filler particles could have a maximum size of 5 μm (d₅₀), preferably 2 μm (d₅₀), and especially preferably, they could be smaller than 1 μm (d₅₀). These filler particle sizes have proven to be suitable for properly coating a nonwoven. Selecting the mean diameter from within this range has proven to be especially advantageous for avoiding short circuits due to the formation of dendritic interpenetrations or abrasion products.

The filler particles could be homogeneously distributed in the body over the entire surface. This concrete configuration is capable of preventing short circuits especially effectively. Metal dendrites and abrasion products are virtually unable to migrate through a homogeneously filled surface. Moreover, this avoids direct contact of the electrodes through such a surface upon exposure to pressure. Before this backdrop, it is concretely conceivable that all of the pores of the nonwoven are homogenously filled with the filler particles in such a way that the separator primarily has mean pore sizes that are smaller than the mean diameter of the filler particles.

The filler particles could be joined to the nonwoven or to each other by binder particles. Here, the binder particles could consist of organic polymers. The use of binder particles consisting of organic polymers makes it possible to produce a separator with adequate mechanical flexibility. Excellent binder properties are surprisingly found in styrene butadiene.

In preferred embodiments, the binder particles could contain polyester, polyamide, polyether, polycarboxylates, a polycarboxylic acid, a polyvinyl compound, a polyolefin, a rubber, a halogenated polymer and/or an unsaturated polymer.

The binder particles could be used in the form of homopolymers or as copolymers. Examples of suitable copolymers include statistic copolymers, gradient copolymers, alternating copolymers, block copolymers or graft polymers. The copolymers can consist of two, three, four or more monomers (terpolymers, tetrapolymers).

Preferably, thermoplastic, elastomeric and/or thermosetting binder particles can be used. Before this backdrop, mention should be made of the following examples: polyvinyl pyrrolidone, polyacrylic acid, polyacrylates, polymethacrylic acid, polymethacrylates, polystyrene, polyvinyl alcohol, polyvinyl acetate, polyacrylamide, polyvinylidene fluoride and copolymers of these, cellulose and its derivates, polyether, polyurethanes, nitrile butadiene rubber (NBR), styrene butadiene rubber (SBR) as well as latex.

In a preferred embodiment, the polymer of which the binder particles are made could be an unsaturated polymer. The unsaturated groups can be, for example, carbon-carbon double or triple bonds or carbon-nitrogen double or triple bonds. C=C double bonds are preferred. They can be uniformly distributed in the polymer such as, for example, polymers that can be obtained through polymerization of dienes. Such polymers can also be partially hydrated. As an alternative, polymer backbone chains can be coupled to radicals that contain unsaturated groups. Unsaturated polymers are generally characterized by good adhesive properties.

In a preferred embodiment, the polymer of which the binder particles are made could be a polyvinyl ether. Suitable momoner building blocks are, for example, methyl-, ethyl-, propyl-, isopropyl-, butyl-, isobutyl-, hexyl-, octyl-, decyl-, dodecyl-, 2-ethylhexyl-, cyclohexyl-, benzyl-, trifluoromethyl-, hexafluoropropyl- or tetrafluoropropylvinyl ether. For example, homopolymers or copolymers, especially block copolymers, can be used here. The copolymers can consist of various monomer vinyl ethers or can be copolymers made from vinyl ether monomers together with other monomers. Polyvinyl ethers are especially well-suited as binders since they have very good bonding and adhesive properties.

In a preferred embodiment, the polymer of which the binder particles are made could be a fluorinated or halogenated polymer. It can be made, for example, of vinylidene fluoride (VDF), hexafluoropropylene (HFP) or chlorotrifluoroethylene (CTFE) or can contain such monomer building blocks. For example, homopolymers or copolymers, especially block copolymers, can be used here. The copolymers can consist of various halogenated monomers or can be copolymers made from halogenated monomers together with other monomers. The polymers and monomers can be completely fluorinated or chlorinated or else partially fluorinated or chlorinated. In a special embodiment of the invention, the comonomer fraction of the halogenated monomers, especially of HFP and CTFE, amounts to between 1% and 25% by weight of the total polymer. Halogenated polymers are generally characterized by a high temperature resistance and chemical resistance as well as by good wettability. They are especially well-suited as binders when fluorinated or partially fluorinated particles are used to fill the nonwoven. The temperature resistance and the processing temperature can be varied over a wide temperature range due to the use of copolymers. As a result, the processing temperature of the binder can be adapted to the melting temperature of the particles.

In another embodiment, the polymer of which the binder particles are made could be a polyvinyl compound. Suitable options are especially those that consist of N-vinylamide monomers such as N-vinyl formamide and N-vinyl acetamide or that contain these monomers. The corresponding homopolymers and copolymers as well as block copolymers are especially well-suited. The poly-N-vinyl compounds are characterized by good wettability.

In another preferred embodiment, the polymer of which the binder particles are made could be a rubber. Generally known rubbers can be used such as ethylene propylene diene monomer rubber (EPDM rubber). Especially EPDM rubber has a high elasticity and good chemical resistance, particularly vis-a-vis polar organic media, and can be used over a wide temperature range. It is also possible to use rubbers that are selected from among natural rubber, isoprene rubber, butadiene rubber, chloroprene rubber, styrene butadiene rubber or nitrile butadiene rubber. These rubbers contain unsaturated double bonds. They stand out for their good adhesive effect. For example, homopolymers or copolymers, especially block copolymers, can be used here.

Fluorinated rubbers can also be used such as perfluoroelastomer (FFKM), fluoroelastomer (FKM) or fluorocarbon elastomer (FPM), as well as copolymers thereof. Special preference is given to FFKM. These polymers, especially FFKM, are characterized by a high temperature application range, very good media resistance and chemical resistance as well as very low swelling. Therefore, they are especially suited for applications in aggressive environments at high temperatures such as in fuel cells.

In a preferred embodiment, the polymer of which the binder particles are made could be a polyester or a polyamide or a copolymer thereof. The copolymers can consist of various polyamide and/or polyester monomers or can be copolymers of such monomers together with other monomers. Such binder particles are characterized by very good adhesive properties.

The binder particles could also comprise polymers containing silicon and/or silicon-organic polymers. On one embodiment, siloxanes are employed as the binder. In another embodiment, silyl compounds and/or silanes are used as binder particles. These binder particles, especially silyl compounds and/or silanes, are preferably used when the filler particles are completely or at least partially organic particles.

The melting point of the binder particles and/or of the filler particles could be below the melting points of the fibers of the nonwoven. By selecting such binder or filler particles, the separator can implement a so-called “shutdown mechanism”. In the case of a “shutdown mechanism”, the melting particles close off the pores of the nonwoven so that no dendritic interpenetrations through the pores can occur that would cause short circuits.

Before this backdrop, it is conceivable that mixtures of filler particles and/or binder particles with different melting points are used. This can achieve a step-wise or gradual closing of the pores as the temperature rises.

The filler particles could consist of organic polymers. Suitable polymers are, for example, polyacetals, polycycloolefin copolymers, polyesters, polyimides, polyether ketones, polycarboxylates and halogenated polymers.

The organic polymers could be homopolymers or copolymers. Examples of suitable copolymers include statistic copolymers, gradient copolymers, alternating copolymers, block copolymers or graft polymers. The copolymers can consist of two, three or more different monomers (terpolymers, tetrapolymers). The cited materials can also be processed in the form of admixtures to form particles. Generally speaking, thermoplastic polymers and polymer mixtures can be used or else crosslinked polymers and polymer mixtures such as elastomers or thermosetting plastics.

The filler particles could especially be made of polypropylene, polyethylene, polyvinyl pyrrolidone, polyvinylidene fluoride, polyester, polytetrafluoroethylene (PTFE), fluorinated ethylene propylene (FEP), polystyrene, polyacrylates as well as copolymers of the above-mentioned polymers. Special preference is given to homopolymers, copolymers or block copolymers of vinylidene fluoride (VDF), of polytetrafluoroethylene (PTFE) and of polyoxymethylene (POM), also polyacetal or polyformaldehyde.

In a preferred embodiment of the invention, the filler particles are made of polyacetals such as polyoxymethylene (POM), or polyacetals containing the filler particles. It is also possible to use copolymers of acetals, for example, with trioxan as the comonomer. Polyacetals are characterized by an excellent dimensional stability and temperature resistance. Moreover, they exhibit very low water absorption. This is advantageous according to the invention since the filled nonwoven then absorbs very little water all in all.

In another embodiment of the invention, the filler particles could consist of or contain cyclo-olefin-copolymers (COC). The thermal properties of COC can be systematically varied over a wide range by changing the incorporation ratio of cyclic to linear olefins and thereby adapted to the desired areas of application. Essentially, this means that the dimensional stability under heat can be selected within a range from 65° C. [149° F.] to 175° C. [347° F.]. The COCs are characterized by extremely low water absorption and very good electric insulation properties.

In another embodiment of the invention, the filler particles could consist of or contain polyesters. Preference is given especially to liquid crystal polyesters (LCP). For example, they are sold by the Ticona company under the trade name “Vectra LCP”. Liquid crystal polyesters are characterized by a high dimensional stability, high temperature resistance and good chemical resistance.

In another embodiment of the invention, the filler particles could consist of or contain polyimides (PI) or copolymers thereof. Suitable copolymers are, for instance, polyetherimides (PEI) and polyamidimides (PAI). The use of polyimides is advantageous since they have a high mechanical strength and a high temperature resistance. Moreover, they exhibit good surface properties that can be systematically selected to range from hydrophilic to hydrophobic.

In a preferred embodiment of the invention, the filler particles could consist of or contain a fluorinated or halogenated polymer. It can be made, for example, of vinylidene fluoride (VDF), polytetrafluoroethylene (PTFE), hexafluoropropylene (HFP) or chlorotrifluoroethylene (CTFE). For example, homopolymers or copolymers, especially block copolymers, can be used here. The copolymers can consist of various halogenated monomers or can be copolymers made from halogenated monomers together with other monomers. The polymers and the monomers can be completely fluorinated or chlorinated or else partially fluorinated or chlorinated. In a special embodiment of the invention, the comonomer fraction of the halogenated monomers, especially of HFP and CTFE, amount to between 1% and 25% by weight of the total polymer. Halogenated polymers are characterized by a high temperature resistance and chemical resistance as well as by good wettability. They are especially well-suited for use with fluorinated or partially fluorinated binder particles. Through the use and selection of copolymers, the temperature resistance and the processing temperature can be varied over a wide temperature range. As a result, the processing temperature of the binder particles can be adapted to the melting temperature of the filler particles. Moreover, this makes it possible to select a shutdown temperature.

Especially preferably, a copolymer made from PTFE and perfluoro-3,6-dioxa-4-methyl-7-octene sulfonic acid (PFSA) could be used. This is available from the DuPont company under the trade name “Nafion”. According to the invention, it is advantageous because it has a good cation and proton conductivity.

The use of organic polymers for the filler particles allows a problem-free melting of the particles in order to achieve a shutdown effect. Moreover, a separator can be produced that can be easily cut to size without crumbling. For the most part, the separator crumbles when a relatively high fraction of inorganic filler particles is present in the separator. Before this backdrop, it is conceivable to use mixtures of different filler particles or core-shell particles. This can achieve a step-wise or gradual closing of the pores in the separator as the temperature rises.

The binder particles and filler particles that can be used, especially the organic filler particles, are preferably highly temperature-resistant. Preferably, the binder particles and/or the filler particles are resistant at temperatures of 100° C. [212° F.], 150° C. [302° F.], 175° C. [347° F.] or 200° C. [392° F.]. This allows their use in fuel cells.

It is also conceivable to use inorganic filler particles or inorganic-organic hybrid particles. These filler particles do not melt below a temperature of 400° C. [752° F.]. Moreover, these filler particles can be selected with basic properties in order to at least partially reduce the proton activity encountered in batteries.

Suitable inorganic filler particles include, for example, metal oxides, metal hydroxides and silicates. They can consist of or contain aluminum oxides, silicon oxides, zeoliths, titanates and/or perowskites. Mixtures of these filler particles or mixtures with other materials can be used.

In one embodiment of the invention, inorganic filler particles that are mixed with organic filler particles could be used. The inorganic filler particles can intrinsically have a fissured or porous structure and can thus increase the porosity, especially of filler particle mixtures. They also have a high temperature resistance, a high chemical resistance and good wettability. Thus, for example, mixtures of organic and inorganic filler particles can be used in which up to 2%, 5%, 10%, 25% or 50% by weight of the filler particles are inorganic filler particles.

It would also be possible to use inorganic filler particles that are spherical or whose external shape has a uniform arrangement of surfaces that approaches being spherical. Such filler particles can be obtained, for example, by crystallization.

The nonwoven described here—in contrast to generally known nonwovens—can also be produced without inorganic filler particles. In one embodiment of the invention, no inorganic filler particles or filler particles with inorganic constituents are present.

The usable filler particles could be produced by generally known methods. Thus, methods are known in which suitable, especially spherical, filler particles are already obtained as the reaction product of the polymerization. Preferred methods are emulsion polymerization or dispersion polymerization.

In another embodiment, the filler particles could be obtained by further processing polymers. For example, polymer granules can be ground up. If applicable, separating processes are subsequently used such as sieving, in order to obtain the desired size distribution. The filler particles can consist of mixtures of different particle sizes. As a result, the porosity and the pore size distribution can be varied.

The fibers of the nonwoven could be made of organic polymers, especially of polybutyl terephthalate, polyethylene terephthalate, polyacrylonitrile, polyvinylidene fluoride, polyetherether ketones, polyethylene naphthalate, polysulfones, polyimide, polyester, polypropylene, polyethylene, polyoxymethylene, polyamide or polyvinyl pyrrolidone. It is also conceivable to use bicomponent fibers that have the above-mentioned polymers. The use of these organic polymers allows the production of a separator that exhibits only a small amount of thermal shrinkage. Moreover, these materials are largely electrochemically stable vis-a-vis the electrolytes and gases used in batteries and capacitors.

The mean length of the fibers of the nonwoven could exceed their mean diameter by a factor of at least two, preferably by a factor of four. Due to this concrete embodiment, an especially tear-resistant nonwoven can be produced since the fibers can be entangled with each other.

At least 90% of the fibers of the nonwoven could have a mean diameter of 12 μm at the maximum. This concrete embodiment allows the structure of a separator having relatively small pore sizes. An even finer porosity can be achieved in that at least 40% of the fibers of the nonwoven have a mean diameter of 8 μm at the maximum.

The separator could be characterized by a thickness of 100 μm at the maximum. A separator of this thickness can still be wound up without any problem and allows a very safe battery operation. Preferably, the thickness could be 60 μm at the maximum. This thickness results in improved winding characteristics and nevertheless, safe battery operation. Especially preferably, the thickness could be 35 μm at the maximum. Separators having such a thickness make it possible to build very compact batteries and capacitors. Most preferably, the thickness could be 25 μm at the maximum. Separators having such a thickness make it possible to build batteries with a high energy density.

The separator could have a porosity of at least 25%. Due to its material density, a separator having this porosity suppresses the occurrence of short circuits especially effectively. Preferably, the separator could have a porosity of at least 35%. A separator having this porosity can yield a battery with a high power density. The separator described here exhibits a high porosity, even though it has very small pores, so that no dendritic interpenetrations can form from one side to the other side of the layer. Before this backdrop, it is conceivable that the pores might form a labyrinthine structure in which no dendritic interpenetrations can form from one side to the other side of the separator. In another embodiment, the porosity is between 25% and 70%, preferably between 35% and 60%, especially preferably between 45% and 55%.

The separator could have pore sizes of 10 μm at the maximum, preferably of 3 μm at the maximum. The selection of this pore size has proven to be especially advantageous for preventing short circuits. Especially preferably, the pore sizes could amount to 1 μm at the maximum. Such a separator especially advantageously prevents short circuits due to metal dendrite growth, due to abrasion products from electrode particles, or due to direct contact of the electrodes upon exposure to pressure.

The weight per unit area of the separator according to the invention could be between 10 and 60 g/m², especially between 15 and 50 g/m².

The separator could have a tear propagation resistance in the crosswise direction of at least 0.3 N, preferably at least 0.5 N, and a tear propagation resistance in the lengthwise direction of at least 0.3 N, preferably 0.4 N. Such a separator is extremely stable and can be wound up without any problem. The higher resistance against tear propagation also diminishes the sensitivity of the material to mechanical stress when it is being cut in the lengthwise and crosswise directions. Furthermore, it improves the safety properties when the impact behavior of a battery in automotive applications is examined by means of bending tests.

The separator could lose its insulating effect if it is positioned between two conductive electrodes while being exposed to a force of at least 500 N, preferably at least 600 N, especially preferably at least 700 N, whereby this is the force with which a plunger having a spherical head and a diameter of 6 mm is pressed onto the assembly consisting of the separator and the electrodes. Such a separator has a high stability and puncture resistance.

The separator could be mechanically strengthened by means of a calandering procedure. Calandering brings about a reduction of the surface roughness. The filler particles and/or binder particles used on the surface of the nonwoven display flattening after the calandering procedure.

The coating could have irregularities that project from the plane by a maximum of 1 μm and/or the coating could have indentations that have a depth of 1 μm at the maximum. Tests on a 30 μm-thick separator have shown that the coating has irregularities that project from the plane by a maximum of 1 μm. Moreover, indentations in the coating have a depth of 1 μm at the maximum. Such a separator has a positive effect on the ageing behavior of the battery.

The flexible inorganic binder particles could have a softening point or glass transition temperature of less than or equal to 20° C. [68° F.], especially preferably of less than or equal to 0° C. [32° F.]. The term flexible organic binder particles as set forth in this description refers to particles having a softening point or glass transition temperature of less than or equal to 20° C. [68° F.]. The combination of these flexible organic binder particles with hard filler particles results in a rubber-like, highly ductile behavior of the separator and brings about a marked increase in the deformation resistance.

The separator described here can be used especially as a separator in batteries and capacitors, since it prevents short circuits particularly effectively.

The separator can also be used in fuel cells as a gas diffusion layer or membrane since it has good wetting properties and can transport liquids.

A separator as put forward in this description refers to an assembly having the features of claim 1.

There are various possibilities for configuring and refining the teaching of the present invention in an advantageous manner. In this context, reference is hereby made to the claims below as well as to the explanation below of preferred embodiments of the invention on the basis of the drawing.

In conjunction with the explanation of the preferred embodiments of the invention on the basis of the drawing, preferred embodiments and refinements of the teaching are also explained in general terms.

### EXEMPLARY EMBODIMENTS

### Example 1

221 parts of a 70% aluminum oxide dispersion (Al₂O₃) (d₅₀=0.7 μm) were added to 251 parts of a 2.5% carboxymethyl cellulose solution and stirred for 30 minutes. Then 10 parts of an alkylphenol ethoxylate and subsequently 24 parts of a 48% colloidal NBR dispersion (pH=9.6; Tg=−12° C. [10.4° F.] (glass transition temperature)) were added, likewise under agitation. The solution was stirred for 2 hours and its stability was tested for at least 24 hours. The viscosity of the obtained solution was 290 cP. The fraction of flexible organic binder particles in the coating was 6.3%).

Coating:

A 65 cm-wide PET nonwoven (thickness: 22 μm, weight per unit area: 11 g/m²) was continuously coated with the above-mentioned solution by means of a roller coating method and dried contact-free at 125° C. [257° F.]. A coated nonwoven with a weight per unit area of 49 g/m² and a thickness of 40 μm was obtained. The mean pore size of the coated nonwoven was 0.2 μm.

### Example 2

46,594 parts of a 66% aluminum oxide dispersion (Al₂O₃) (d₅₀=2.5 μm) were added to 98,010 parts of a 1.5% carboxymethyl cellulose solution and stirred for 30 minutes. Then 3000 parts of an alkylphenol ethoxylate and subsequently 5396 parts of a flexible 48% colloidal NBR dispersion (pH=9.6; Tg=−12° C. [10.4° F.] were added, likewise under agitation. The solution was stirred for 3 hours and its stability was tested for at least 24 hours. The viscosity of the obtained solution was 100 cP. The solids fraction of flexible organic binder particles in the coating was 7.4%.

Coating:

A 58 cm-wide PET nonwoven (thickness: 19 μm, weight per unit area: 11 g/m²) was continuously coated with the above-mentioned solution by means of a roller coating method and dried at a temperature of 120° C. [248° F.]. An impregnated nonwoven with a weight per unit area of 35 g/m² and a thickness of 36 μm was obtained. The mean pore size was 0.2 μm.

### Example 3

221 parts of a 65% aluminum oxide suspension (Al₂O₃) (d₅₀=2 μm) were added to 251 parts of a 2% carboxymethyl cellulose solution and stirred for 30 minutes. Then 5 parts of an alkylphenol ethoxylate and subsequently 40 parts of a 48% colloidal NBR binder dispersion were added, likewise under agitation. The solution was stirred for 3 hours and its stability was tested for at least 24 hours. The viscosity of the obtained solution was 290 cP. The solids fraction of flexible organic binder particles was 11.1%.

Coating:

A 58 cm-wide PET nonwoven (thickness: 20 μm, weight per unit area: 11 g/m²) was continuously coated with the above-mentioned solution by means of a roller coating method and dried at a temperature of 120° C. [248° F.]. An impregnated nonwoven with a weight per unit area of 31 g/m² and a thickness of 34 μm was obtained. The mean pore size was 0.6 μm.

### Comparative Example 1

Type Celgard 2320, three-layer dry membrane (polypropylene/polyethylene/polypropylene), thickness of 20 μm

Comparative Example 2

Type Tonen E 16 MMS, wet membrane (Polyolefin), thickness of 15 μm

### Comparative Example 3

Ceramic separator, thickness of 31 μm

The following measuring methods were used in order to determine the weight, the thickness, the puncture resistance, the tear propagation resistance and the Gurley units:

Weight:

Based on European testing standard EN 29073-Part 1, three specimens measuring 100×100 mm in size were punched out in order to determine the weights per unit area, the specimens were weighed and the measured value was multiplied by 100.

Thickness:

Based on European testing standard EN 29073-Part 2, the thickness was measured in a precision thickness measuring device, Model 2000 U/Elektrik. The measuring surface area was 2 cm², the measuring pressure was 1000 cN/cm².

Puncture resistance:

This method is based on:
“Battery Conference on Applications and Advances, 1999. The Fourteenth Annual”, pages 161 to 169.

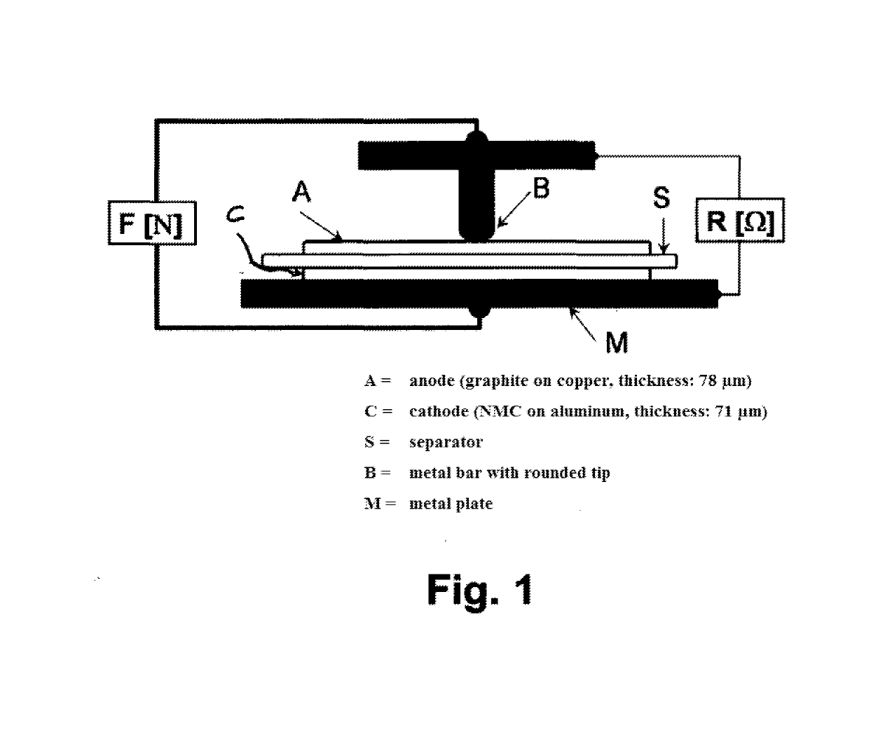

This method determines the requisite force to which a separator has to be exposed under defined conditions for it to lose its electric insulating effect. The measuring arrangement is shown in FIG. 1. The separator S that is to be tested is positioned between an anode A (graphite on copper foil, total thickness: 78 μm, commercially available) and a cathode C (nickel manganese cobalt oxide on aluminum foil, thickness of 71 μm, commercially available), in order to replicate the arrangement in a battery cell. These three layers are placed onto a hardened and polished steel plate M, then a rounded and likewise hardened metal plunger B (diameter=6 mm) is placed onto the specimen, and this metal plunger B is brought into contact with the iron plate M. The pressure on the three layers (battery component assembly) is increased until a short circuit occurs, that is to say, until the separator S is damaged, and the anode A and the cathode C come into direct contact with each other. The force on the metal plunger B at which the electric resistance R abruptly drops to below 100,000 Ohm is measured.

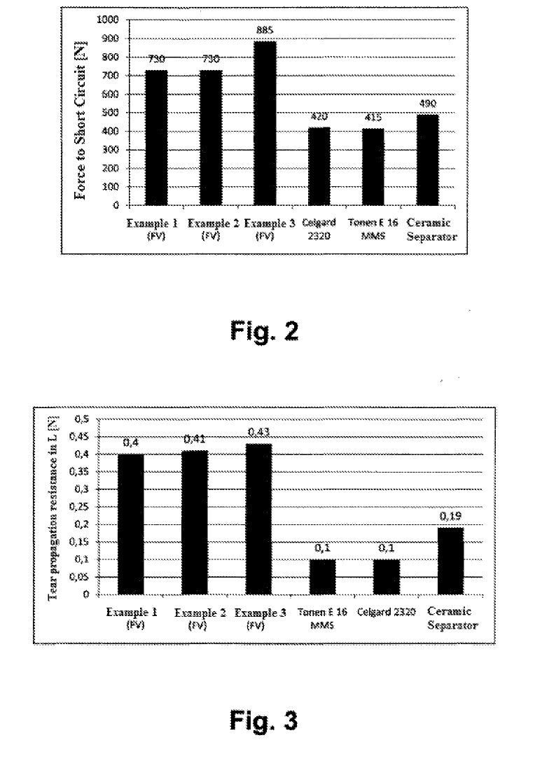

The forces measured in the examples and in the comparative examples are shown in FIG. 2 in a diagram. It can be seen that the forces that need to be applied in Examples 1 to 3, namely, 730 N and 885 N, are considerably higher than the forces in the comparative examples, namely, 420 N, 415 N, 490 N. The separators according to the invention are thus much more stable than the separators of the state of the art.

Tear propagation resistance:

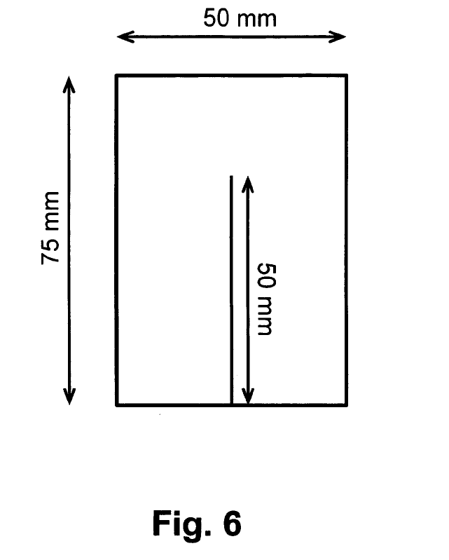

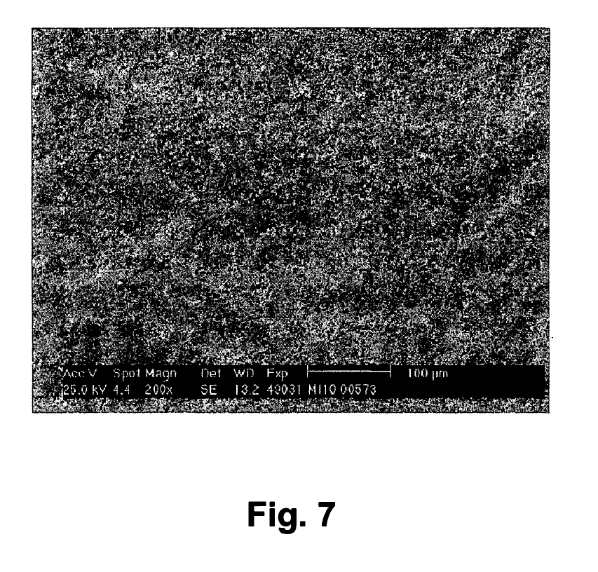

Based on German test standard DIN 53859, the tear propagation resistance of the separators was determined. For this purpose, three specimens measuring 75×50 mm and having a notch of 50 mm were punched out in the MD (“machine direction”, production direction of the nonwoven) and in the CD (“cross direction”, orthogonal to the production direction of the nonwoven). This is schematically shown in FIG. 6. The legs of the measuring specimens formed by the notch are clamped into gripping clamps of a tensile testing machine (clamp distance of 50 mm) and pulled apart at a speed of 200 mm/min. Since separators often do not tear in the cutting direction, the measuring specimens that tear sideways also have to be taken into consideration. The average of the ascertained values was taken.

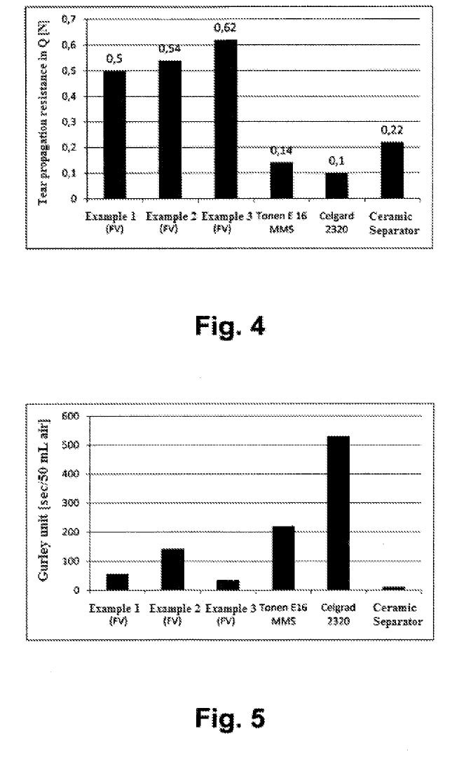

The values measured for the tear propagation resistance of the examples and comparative examples are plotted in FIGS. 3 and 4. Here, too, it can be seen that the separators according to the invention are much more stable than the separators of the state of the art.

Gurley unit:

Based on test standard (ISO 9237), the Gurley units of the separators were determined by means of a Standard Gurley Densometer made by the company Frank Prufgerate GmbH (Model F40450). The measuring surface area was 6.4516 cm², the air volume was 40 cm³. The values of the measured Gurley units are shown in FIG. 5 and are below 150 s/50 ml of air, preferably below 100 s/50 ml of air.

FIG. 7 shows a scanning electron microscope (SEM) image of a separator according to the invention. FIG. 7 clearly shows how homogeneous and uniform the coating containing cellulose derivatives is.

Regarding additional advantageous embodiments and refinements of the teaching according to the invention, reference is hereby made, on the one hand, to the general part of the description and, on the other hand, to the accompanying claims.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the attached claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise.

1: A separator, comprising a body of nonwoven, the body comprising a coating, wherein the coating comprises:
filler particles;
cellulose;
flexible organic binder particles,
wherein the filler particles and the flexible organic binder particles are joined to each other by the cellulose, and
wherein the cellulose comprises a cellulose derivative having a chain length of at least 100 repeat units.

2: The separator of claim 1, wherein the cellulose comprises a cellulose derivative comprises a cellulose ether.

3: The separator of claim 1, wherein the coating comprises a non-ionic surfactant comprising a octylphenol ethoxylate, a nonylphenol ethoxylate, an alkylated ethylene oxide/polypropylene oxide copolymer, or a mixture of one or more of any of these.

4: The separator of claim 1, wherein the flexible organic binder particles make up a fraction of at least 2% by weight of the coating.

5: The separator of claim 1, wherein the binder particles comprise a polyester, polyamide, polyether, polycarboxylate, polycarboxylic acid, polyvinyl compound, polyolefin, rubber, halogenated polymer, polyvinyl pyrrolidone, polyacrylic acid, polyacrylate, polymethacrylic acid, polymethacrylate, polystyrene, polyvinyl alcohol, polyvinyl acetate, polyacrylamide, cellulose, a cellulose derivate, polyether, polyurethane, nitrile butadiene rubber (NBR), styrene butadiene rubber (SBR), latex, fluorinated polymer, chlorinated polymer, siloxane, silyl compound, silane, unsaturated polymer, a copolymer of one or more, of any of these, or a mixture of one or more of any of these.

6: The separator of claim 1, wherein at least some filler particles comprise a polyacetal, polycycloolefin copolymer, polyester, polyimide, polyether ketone, polycarboxylate, halogenated polymer, unsaturated polymer, polypropylene, polyethylene, polyvinylpyrrolidone, polyvinylidene fluoride, polyester, fluorinated polymer, chlorinated polymer, polytetrafluoroethylene, fluorinated ethylene propylene (FEP), polystyrene, polyacrylate, polymethacrylate, polyetheramide, polyetherimide, polyether ketone, a copolymer of one or more of any of these, or a mixture of one or more of any of these.

7: The separator of claim 1, wherein at least some of the filler particles are in the form of inorganic particles.

8: The separator according to claim 7, wherein the inorganic particles comprise a metal oxide, metal hydroxide, a silicate, or a mixture of one or more of any of these.

9: The separator of claim 1 wherein the nonwoven comprises a fiber comprising polybutyl terephthalate, polyethylene terephthalate, polyacrylonitrile, polyvinylidene fluoride, polyetherether ketone, polyethylene naphthalate, polysulfone, polyimide, polyester, polypropylene, polyethylene, polyoxymethylene, polyamide, polyvinylidene fluoride or polyvinyl pyrrolidone.

10: The separator of claim 1 having a tear propagation, resistance in the crosswise direction of at least 0.3 N, and by a tear propagation resistance in the lengthwise direction of at least 0.3 N.

11: The separator of claim 1 which the separator loses its insulating effect if it is positioned between two conductive electrodes while being exposed to a force of at least 500 N
wherein the force is that with which a plunger having a spherical head and a diameter of 6 mm is pressed onto an assembly comprising the separator and the electrodes.

12: The separator of claim 1, produced by a process comprising calendaring.

13. The separator of claim 1, wherein the coating comprises
an irregularity that projects from the plane by a maximum of 1 μm,
an indentation with that have a depth of 1 μm at the maximum, or
the irregularity and the indentation.

14. The separator of claim 1, wherein the flexible inorganic binder particles have a softening point or glass transition temperature of less than or equal to 20° C.

15: The separator of claim 1, wherein the cellulose derivative has a chain length of at least 200 repeat units.

16: The separator of claim 1, wherein the cellulose derivative comprises a cellulose ester.

17: The separator of claim 1, wherein the cellulose derivative comprises a cellulose ether and a cellulose ester.

18: The separator of claim 1, wherein the flexible organic binder particles make up a fraction of at least 5% by weight of the coating.

19: The separator of claim 1, wherein the flexible organic binder particles make up a fraction of at least 10% by weight of the coating.

20: The separator of claim 1, wherein the inorganic particles comprise an aluminum oxide, silicon oxide, zeolith, titanate, perowskite, or a mixture of one or more of any of these.
